(19) United States
(12) Patent Application Publication
(10) Pub. No.: US 2008/0306806 A1
(43) Pub. Date: Dec. 11, 2008

(54) METHODS AND APPARATUS FOR DYNAMICALLY ALLOCATING TASKS

(75) Inventors: Adriaan Van Wyk, Strubensvalley (ZA); Wynand du Toit, Little Falls (ZA); Jacobus du Preez, Snoqualmie, WA (US)

Correspondence Address: BELL, BOYD & LLOYD, LLP, P.O. Box 1135, CHICAGO, IL, 60690, US

(73) Assignee: SOURCECODE TECHNOLOGY HOLDING, INC., Redmond, WA (US)

(21) Appl. No.: 12/054,250

(22) Filed: Mar. 24, 2008

Related U.S. Application Data
(60) Provisional application No. 60/896,730, filed on Mar. 23, 2007.
(60) Provisional application No. 60/941,902, filed on Jun. 4, 2007.

(51) Int. Cl. G06Q 10/00

(52) U.S. Cl. 705/9

(57) ABSTRACT

The present disclosure provides methods and apparatuses for dynamically allocating tasks. Using the methods and apparatus herein, users can dynamically assign tasks to roles within a workflow process. This allows business process designers to easily create tasks and define roles for those tasks.

### CROSS-REFERENCE TO RELATED APPLICATIONS

The present application claim benefit to U.S. Patent Application No. 60/896,730, METHOD AND APPARATUS FOR DESIGNING WORK FLOWS, filed on Mar. 23, 2007; and U.S. Patent Application No. 60/941,902, METHODS AND APPARATUS FOR DYNAMICALLY ALLOCATING TASKS, filed on Jun. 4, 2007, the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Business can now also incorporate business process design into their existing technology systems. Instead of providing a simple map of a business process, integration with computer systems allows business process designers to design interactive business processes that drive business workflow. Business process designers can receive data from various sources and perform a wide range of actions on the data directly, and create business processes in an easy to understand visual manner.

A business process will often have tasks that users must complete within the workflow. For example, a manager may need to approve an order before the order will be completed. Currently, in order to set up tasks for a user, the business process designed must create a static association. The static association is hard-coded into the business process design and requires technical knowledge to create and modify.

### SUMMARY

The present disclosure provides methods and apparatuses for dynamically allocating tasks. Using the methods and apparatus herein, users can dynamically assign tasks to roles within a workflow process. This allows business process designers to easily create tasks and define roles for those tasks.

Additional features and advantages are described herein, and will be apparent from, the following Detailed Description and the figures.

### BRIEF DESCRIPTION OF THE FIGURES

FIG. 1 is a high level block diagram of an example business process design system.

FIG. 2 is a more detailed block diagram showing one example of a client device.

FIG. 3 is a more detailed block diagram showing one example of a server.

FIG. 4 is an example process for creating dynamically allocated tasks.

FIG. 5 is an example of a role creation screen.

### DETAILED DESCRIPTION

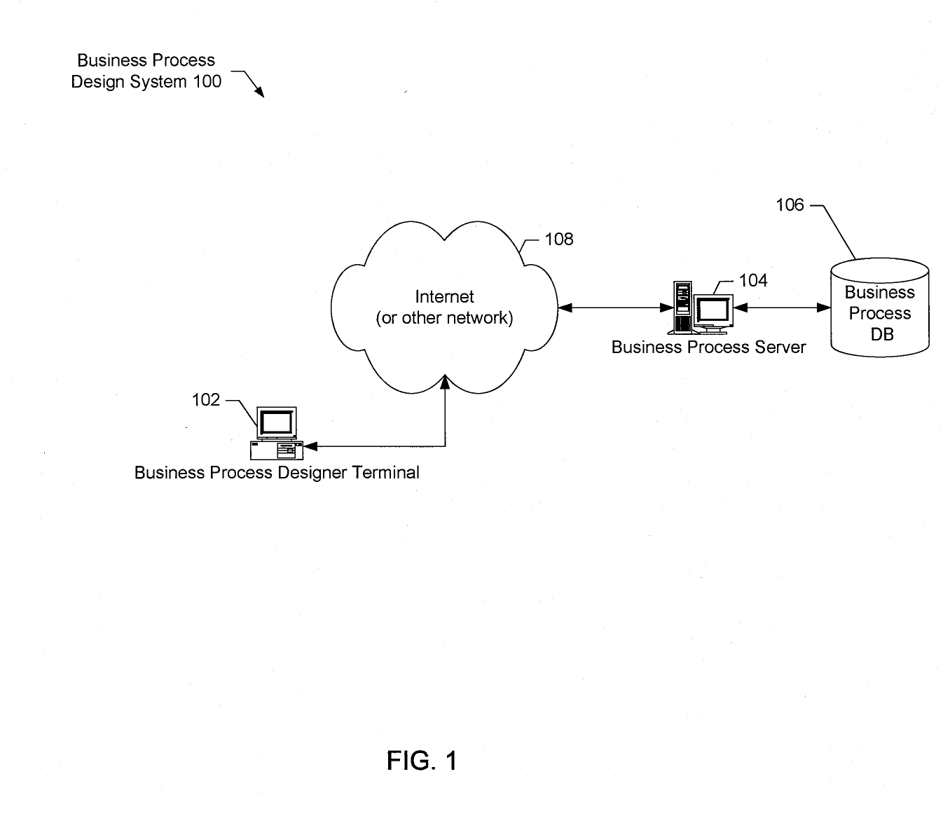

The present system is most readily realized in a network communications system. A high level block diagram of an exemplary network communications system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

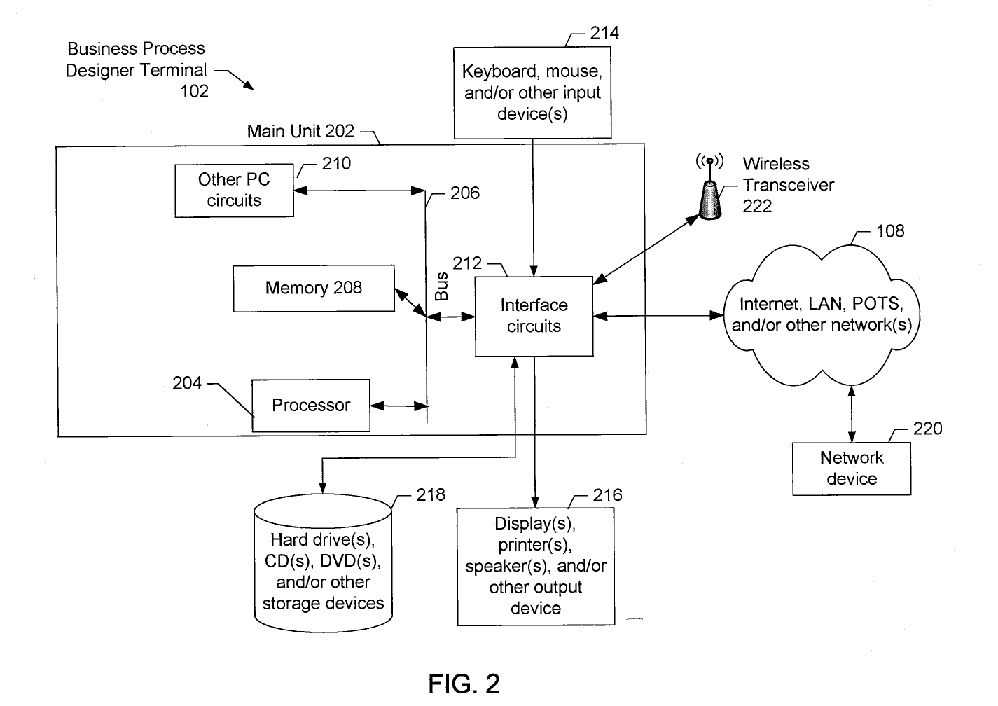

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214. Preferably, the memory 208 stores a software program that implements all or part of the method described below.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

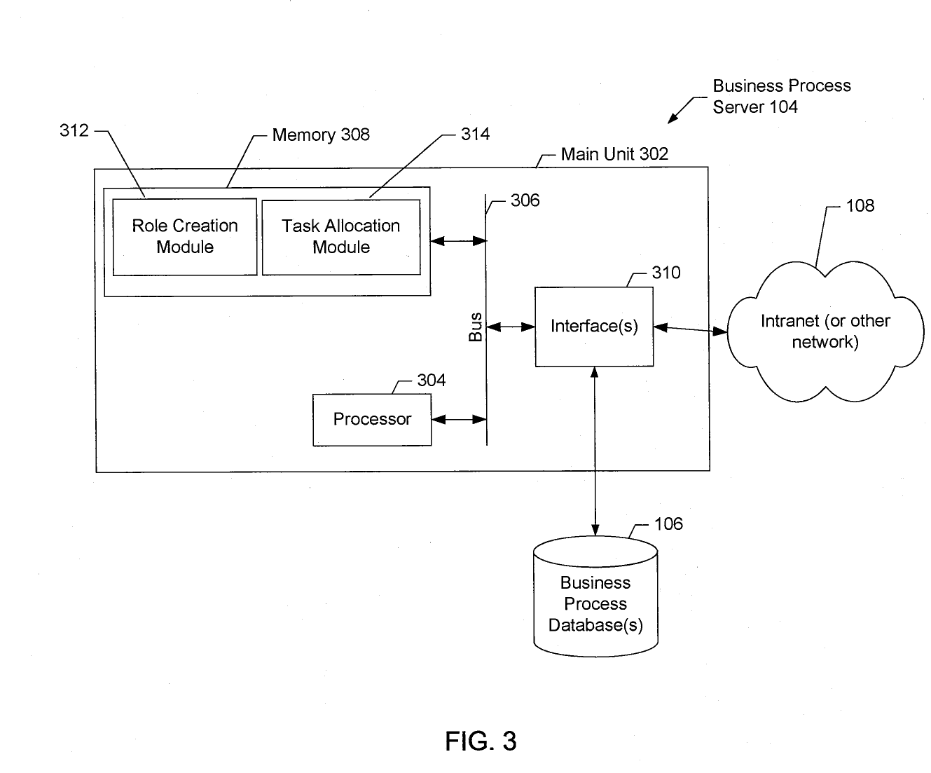

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

In particular, the memory 308 preferably stores role creation module 312 and a task allocation module 314. The role creation module 312 may contain the instructions to create roles within a workflow process. The task allocation module 314 may contain the instructions to create tasks and to allocate the tasks to roles created in the role creation module 312 at runtime.

The role creation module 312 allows a business process designer to create a role for a workflow process. A role may be users or groups from Active Directory, SQL or other similar user providers, other previously created roles for the workflow process, or results from workflow methods. The ability to span user providers and define roles with a workflow method is beneficial in allowing the business process designer to create more powerful and flexible roles.

The role creation module 312 allows the business process designer to include or exclude users or groups from the role. For example, a “Main Users” role may include all users from a “Users” group and exclude a user, “John B.” The “Main Users” role would include all of the users from the “Users” group except for “John B.” The ability to include or exclude role items from a role allows for greater flexibility in creating roles.

The role creation module 312 also determines the role membership. For example, the role creation module 312 may resolve the membership of the role every 10 minutes, so updates to the elements that comprise the role will be updated at a predetermined interval. For example, the role creation module 312 may update a role membership every 10 minutes and add or remove tasks assigned to a member based on the membership changes. “User A” and “User B” may be members of “Role 1” that “Task 1” is assigned to. At the beginning of the 10 minutes, “Task 1” may be in the worklist for both “User A” and “User B.” If “User A” is removed from the “Role 1,” and the 10 minute interval passes without “User A” or “User B” servicing “Task 1,” the role creation module 312 may remove “Task 1” from “User A's” worklist when updated “Role 1's” membership. The role creation module 312 allows the user to determine when the role will be updated, instead of the pre-set 10 minute interval. The role creation module 312 also allows the user to set task allocation so that a single task item is assigned to every individual member of a role.

The role creation module 312 also allows the user to dynamically resolve the role membership. For example, the role creation module 312 may update a role membership each time a worklist is opened for a user. For example, if a solution requires tasks to be assigned to the role Sales and all users in Sales role should have access to action the task, then a role can be created to on-demand and dynamically resolve if a user is in the role Sales and then make the task available to that user. When a user opens their worklist the determination is made to see if they are a member of any roles that have been assigned work dynamically and if so, the tasks will be visible to them.

The role creation module 312 also creates the rights of the role and the users within the role. For example, if a role is added to workflow activity, the role creation module 312 may assign the role, and the role's members, the same rights as the activity.

The task allocation module 314 allocates tasks to the roles defined in the role creation module 312. A task is an activity that a user must complete. For example, a user may have to approve an order before the order is processed by a processing department. The role creation module 312 may allow the business process designer to designate that any member of a role can complete an assigned task. For example, a “supervisors” role may have an “approval” task and any supervisor may complete the “approval task.”

The task allocation module 312 also handles assigning rights during run time, so that changes to the rights of a task at run time are possible. The default actions and rights are defined at design time within the process definition; however changes are possible during run time. For example, a user may delegate a task to a destination user and the rights for the task will change based on the delegation. In this example, the rights to the task will exist for both the user and the destination user, so that the task will appear to both users. In another example, a first user may redirect a task to second user, and the rights will be transferred from the first user to the second user and the task will not appear on the first user's task list.

The task allocation module 312 utilizes a context grid to handle assigning tasks. The context grid serves to define and manage the specific actions that users can perform to a workflow task at a specific point in a workflow. The specific point can further be defined as either a specific status established by the workflow data or external data, or may be linked to an absolute or relative moment in time. For example, the context grid may map a “Manager Approval” task to “Approve,” “Decline,” or “Query” actions and the user, groups or role that can perform the action. The mapping can occur both at the design of the business process and dynamically during the execution of the process. Further, the actions that can be performed at each step in a process effecting the security mappings between the action and those who can perform actions on the context grid

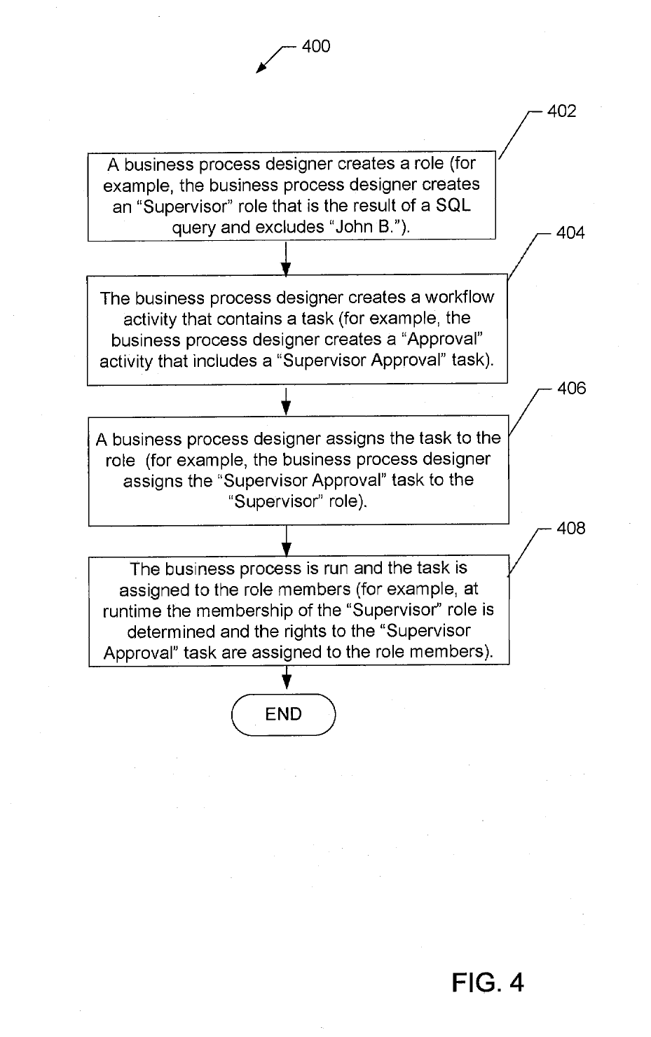

A flowchart of an example process 400 for creating dynamically allocated tasks is shown in FIG. 4. Preferably, the process 400 is embodied in one or more software programs stored in one or more memories and executed by one or more processors. Although the process 400 is described with reference to the flowchart illustrated in FIG. 4, it will be appreciated that many other methods of performing the acts associated with process 400 may be used. For example, the order of many of the acts may be changed, and some of the acts described may be optional.

In this example, the business process designer creates a role (block 402). For example, the business process designer creates a “Supervisor” role by interfacing with the role creation module 312. The role may include users returned from a SQL query and exclude a user “John B.” from the role.

The business process designer creates a workflow activity that contains a task in block 404. For example, the business process designer may create an “Approval” activity as a workflow element that contains a “Supervisor Approval” task. The business process designer may use a graphical user interface to design the workflow process and workflow process elements.

The business process designer assigns the task to the role in block 406. For example, the business process designer may be presented with a listing of available roles to assign the task to in the graphical user interface and select the “Supervisor” role for the “Supervisor Approval” task.

The business process is run and the task is assigned to the role members in block 408. For example, the processor 304 may execute a workflow process and the task allocation module 314 may assign the task at runtime to the members of the “Supervisor” role. The role creation module 312 handles determining the members of the role, either at pre-set intervals or every time a worklist that uses the role is opened. In this way the role may be dynamically updated. The task allocation module 314 may assign or transfer the rights to a task to role members. For example, a first user may delegate the role to a second user and the rights to the task will be copied from the first user to the second user. In delegation, the first user retains rights to the task as well.

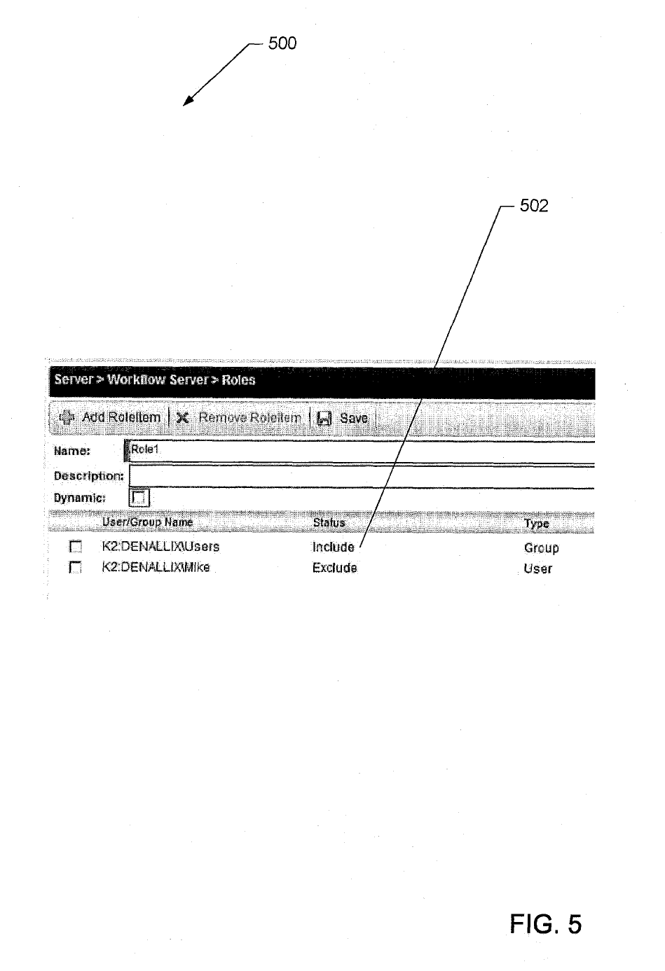

A screenshot of an example role creation screen 500 is presented in FIG. 5. Although the example role creation screen 500 is described in reference FIG. 5, it will be appreciated that many other configurations are possible. For example, elements could be in different locations, elements could have different names, and elements could have different graphical representations.

The role creation screen 500 may contain a listing of role members 502. The role creation module 312 may present a graphical user interface to the business process designer in order to facilitate role creation. The role creation module 312 may allow the business process designer to easily add or remove and include or exclude individual users, groups from outside sources such as SQL, Active Directory, etc., other roles, or workflow methods.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for dynamically allocating tasks, the method comprising:
creating a role, wherein the role contains a member;
creating a workflow activity;
creating a task, wherein the task is associated with the workflow activity;
assigning the task to the role;
executing the workflow;
creating a context grid based on the task and the role;
using the context grid to allocate the task to the role;
resolving the member to the role;
receiving a task completion from the member; and
removing the task from the role.

2. The method of claim 1, wherein resolving the member of the role includes interval based resolution and real-time resolution.

3. The method of claim 1, wherein the member is a first member and the role excludes a second member.

4. The method of claim 1, wherein creating the role includes receiving a member search result from an external system.

5. The method of claim 1, wherein executing the workflow includes dynamically determining a role membership.

6. The method of claim 1, wherein the member is a first member and including receiving a task reassignment from the first member to a third member and allocating the task to the third member.

7. The method of claim 6, wherein allocating the task to the third member includes removing a right to the task from the first member.

8. The method of claim 1, wherein the role is a first role and wherein the first role includes a second role.

9. A system for dynamically allocating tasks, the system comprising:
a processor for:
creating a role, wherein the role contains a member;
creating a workflow activity;
creating a task, wherein the task is associated with the workflow activity;
assigning the task to the role;
executing the workflow;
creating a context grid based on the task and the role;
using the context grid to allocate the task to the role;
resolving the member to the role;
receiving a task completion from the member; and
removing the task from the role.

10. The system of claim 9, wherein resolving the member of the role includes interval based resolution and real-time resolution.

11. The system of claim 9, wherein the member is a first member and the role excludes a second member.

12. The system of claim 9, wherein creating the role includes receiving a member search result from an external system.

13. The system of claim 9, wherein executing the workflow includes dynamically determining a role membership.

14. The system of claim 9, wherein the member is a first member and including receiving a task reassignment from the first member to a third member and allocating the task to the third member.

15. The system of claim 14, wherein allocating the task to the third member includes removing a right to the task from the first member.

16. The system of claim 9, wherein the role is a first role and wherein the first role includes a second role.

17. A computer readable medium storing instructions to cause a computing device to:
create a role, wherein the role contains a member;
create a workflow activity;
create a task, wherein the task is associated with the workflow activity;
assign the task to the role;
execute the workflow;
create a context grid based on the task and the role;
use the context grid to allocate the task to the role;
resolve the member to the role;
receive a task completion from the member; and
remove the task from the role.

18. The computer readable medium of claim 17, wherein resolving the member of the role includes interval based resolution and real-time resolution.

19. The computer readable medium of claim 17, wherein the member is a first member and the role excludes a second member.

20. The computer readable medium of claim 17, wherein creating the role includes receiving a member search result from an external system.

21. The computer readable medium of claim 17, wherein executing the workflow includes dynamically determining a role membership.

22. The computer readable medium of claim 17, wherein the member is a first member and the computer readable medium includes instructions to cause the computing device to receive a task reassignment from the first member to a third member and allocate the task to the third member.

23. The computer readable medium of claim 22, wherein allocating the task to the third member includes removing a right to the task from the first member.

24. The computer readable medium of claim 17, wherein the role is a first role and wherein the first role includes a second role.
